(19) United States
(12) Patent Application Publication
(10) Pub. No.: US 2025/0021150 A1
(43) Pub. Date: Jan. 16, 2025

(54) SYSTEMS AND METHODS FOR RESPONDER PASSIVE MODE OPERATION

(71) Applicant: Meta Platforms Technologies, LLC, Menlo Park, CA (US)

(72) Inventors: Muhammad Kumail Haider, Sunnyvale, CA (US); Davide Magrin, Villa del Conte (IT); Guoqing Li, Cupertino, CA (US)

(73) Assignee: Meta Platforms Technologies, LLC, Menlo Park, CA (US)

(21) Appl. No.: 18/590,559

(22) Filed: Feb. 28, 2024

Related U.S. Application Data
(60) Provisional application No. 63/526,069, filed on Jul. 11, 2023.

(51) Int. Cl. G06F 1/3209; H04L 65/611

(52) U.S. Cl. CPC G06F 1/3209; H04L 65/611

(57) ABSTRACT

Systems, methods, and devices for responder passive mode operation may include a target wake time (TWT) scheduling device which generates a broadcast TWT element, the broadcast TWT element including a control field including a responder passive mode (PM) mode sub-field. The TWT scheduling device may transmit the broadcast TWT element to one or more TWT scheduled devices within a basic service set (BSS) of the TWT scheduling device.

### CROSS-REFERENCE TO RELATED APPLICATIONS

This application claims the benefit of and priority to U.S. Provisional Application No. 63/526,069, filed Jul. 11, 2023, the contents of which are incorporated herein by reference in their entirety.

### FIELD OF DISCLOSURE

The present disclosure is generally related to communications, including but not limited to systems and methods for responder passive mode operation.

### BACKGROUND

Artificial reality, such as virtual reality (VR), augmented reality (AR), or mixed reality (MR), provides immersive experience to a user. In one example, a user wearing a head wearable display (HWD) can turn the user's head to one side, and an image of a virtual object corresponding to a location and/or an orientation of the HWD and a gaze direction of the user can be displayed on the HWD to allow the user to feel as if the user is moving within a space of an artificial reality (e.g., a VR space, an AR space, or a MR space). An image of a virtual object may be generated by a computing device communicatively coupled to the HWD. In some embodiments, the computing device or HWD may have access to a network.

The HWD, computing device, or other network connected devices can include devices to function as, for example, an access point (AP), or other network station (STA). Limiting power usage of such devices can extend battery life, limit carbon emissions, or avoid exceeding thermal limits. The devices may switch to a sleep state during times of non-operation to limit power usage. However, during a sleep state, the device may become unavailable to other network connected devices. For example, an AP switching to a sleep state may become unavailable to various STA devices of a same basic service set (BSS). If the STA are not provided an indication of such unavailability to schedule communications with the AP, network communications can incur latency according to transmission delays. Such latency may be aggravated by network congestion as various STAs may retry communications with the unavailable AP, increase a transmit power, or so forth. Such latency may cause judder or other perceptible anomalies in the display of the virtual objects for the user, or otherwise impact network operations.

### SUMMARY

In one aspect, this disclosure is directed to a method. The method may include generating, by a target wake time (TWT) scheduling device, a broadcast TWT element, the broadcast TWT element comprising a control field including a responder passive mode (PM) mode sub-field. The method may include transmitting, by the TWT scheduling device, the broadcast TWT element to one or more TWT scheduled devices within a basic service set (BSS) of the TWT scheduling device.

In some embodiments, transmitting the broadcast TWT element includes broadcasting, by the TWT scheduling device, the broadcast TWT element for receipt by each of the one or more TWT scheduled devices within the BSS of the TWT scheduling device. In some embodiments, the broadcast TWT element is for a type 3 negotiation for a TWT schedule. In some embodiments, the broadcast TWT element is for a type 2 negotiation for a TWT schedule. In some embodiments, the TWT scheduling device includes an access point, and the one or more TWT scheduled devices include one or more station devices.

In some embodiments, the method includes receiving, by the TWT scheduling device, a TWT request from a TWT scheduled device. Transmitting the broadcast TWT element can include transmitting, by the TWT scheduling device, the broadcast TWT element to the TWT scheduled device in a TWT response frame responsive to the TWT request. In some embodiments, the method includes determining, by the TWT scheduling device, that each of the one or more TWT scheduled devices support a broadcast TWT operation. The TWT scheduling device can set a value for the responder PM mode sub-field responsive to determining that each of the one or more TWT scheduled device support the broadcast TWT operation. In some embodiments, the method includes switching, by the TWT scheduling device, to a sleep state outside of a service period of a TWT schedule for the BSS, according to a value of the responder PM mode sub-field. In some embodiments, the TWT scheduling device switches to (e.g., entering, or transitioning to) the sleep state outside of the service period of any of a plurality of TWT schedules for the BSS, the plurality of TWT schedules comprising one or more of a broadcast TWT schedule, a restricted TWT schedule, or an individual TWT schedule.

In some embodiments, the method includes switching, by the TWT scheduling device, from a first channel corresponding to the BSS, to a second channel, outside of a service period of a TWT schedule for the BSS on the first channel, according to a value of the responder PM mode sub-field. In some embodiments, the TWT scheduling device switches to the second channel outside of the service period of any of a plurality of TWT schedules for the BSS on the first channel, the plurality of TWT schedules comprising one or more of a broadcast TWT schedule, a restricted TWT schedule, or an individual TWT schedule. In some embodiments, the method includes setting, by the TWT scheduling device, a value for a TWT required subfield in a high efficiency (HE) operation parameters element, according to a value of the responder PM mode sub-field of the broadcast TWT response element.

In one aspect, this disclosure is directed to a device. The device includes a transceiver and one or more processors. The one or more processors can be configured to generate a broadcast target wake time (TWT) element, the broadcast TWT element including a control field including a responder passive mode (PM) mode sub-field. The one or more processors can be configured to transmit, via the transceiver, the broadcast TWT element to one or more TWT scheduled devices within a basic service set (BSS) of the TWT scheduling device.

In some embodiments, the one or more processors are configured to transmit the broadcast TWT element by broadcasting the broadcast TWT element for receipt by each of the one or more TWT scheduled devices within the BSS of the TWT scheduling device. In some embodiments, the one or more processors are configured to receive, via the transceiver a TWT request from a TWT scheduled device. The one or more processors can transmit the broadcast TWT element to the TWT scheduled device in a TWT response frame responsive to the TWT request. In some embodiments, are configured to determine that each of the one or more TWT scheduled devices support a broadcast TWT operation. The one or more processors can set a value for the responder PM mode sub-field responsive to determining that each of the one or more TWT scheduled device support the broadcast TWT operation.

In some embodiments, the one or more processors are configured to switch the device to a sleep state outside of a service period of a TWT schedule for the BSS, according to a value of the responder PM mode sub-field. In some embodiments, the one or more processors switch the device to the sleep state outside of the service period of any of multiple TWT schedules for the BSS, the multiple TWT schedules including one or more of a broadcast TWT schedule, a restricted TWT schedule, or an individual TWT schedule. In some embodiments, the one or more processors are configured to switch from a first channel corresponding to the BSS, to a second channel, outside of a service period of a TWT schedule for the BSS on the first channel, according to a value of the responder PM mode sub-field. In some embodiments, the one or more processors switch to the second channel outside of the service period of any of a plurality of TWT schedules for the BSS on the first channel, the plurality of TWT schedules comprising one or more of a broadcast TWT schedule, a restricted TWT schedule, or an individual TWT schedule.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing TWT, according to an example implementation of the present disclosure.

FIG. 5 is a diagram showing an example frame structure of a target wake time (TWT) element, configured for provision to a scheduled device by a scheduling device, according to an example implementation of the present disclosure.

FIG. 6 is a timing diagram showing a schedule for computing devices of a basic service set (BSS) utilizing TWT, according to an example implementation of the present disclosure.

FIG. 7 is a block diagram of a computing environment, according to an example implementation of the present disclosure.

FIG. 8 is a flowchart showing an example method of TWT broadcast scheduling, according to an example implementation of the present disclosure.

FIG. 9 is a flowchart showing an example method of TWT broadcast scheduling, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Energy saving may be desirable in many devices due to environmental, battery life, or thermal concerns, including various devices of an AR/VR context. Such devices can include STAs, and APs, including a mobile AP (“hotspot”), other soft AP, or Wi-Fi direct group owner (GO). One approach to energy savings is to cause devices (e.g., transceivers or processors thereof) to opportunistically switch to (e.g., enter) low-power states, which may be referred to as, for example, doze modes, sleep states, etc. During a wake time, the devices may be in an awake/available state (e.g., its wireless communication module/interface is in a fully powered-up ready, or wake state) and is able to transmit and/or receive. During other times, a device may be unavailable (e.g., its wireless communication module/interface is in a powered-down, low power, or sleep state).

A Target Wake Time (TWT) is a mechanism where active time is arbitrated between devices according to a set of service periods (SPs). The SPs are defined and shared between devices to reduce medium contention and improve the power efficiency of network devices. The TWT may reduce energy consumption of the devices by limiting the awake time and associated power consumption of the devices. However, a device may not always sleep during an SP. For example, in a network with a Wi-Fi AP connected to mains power, and various low power station (STA) devices associated therewith, the AP may remain generally available during the interstitial periods between SPs. For example, if a STA device generates uplink traffic between SP (e.g., responsive to a locally driven interrupt), the STA may provide the uplink traffic in an interstitial period. Such a SP during which some devices remain available may be referred to as one-way SP: the AP may not expect the STA devices to be available outside of scheduled SP, but the STA may expect the AP to be available.

Although such a one-way SP can operate well in many networks, such as where the AP is not power constrained and is not configured to monitor more than one channel, some AP devices (and other TWT scheduling devices) may be power constrained, or may be configured to operate across various networks during interstitial periods. Such an AP can, according to the present disclosure, provide a broadcast message indicating, to various STA devices, that the SP will, or will not, be available during interstitial periods between SP. Such a broadcast message can reduce congestion and overhead in a network, relative to negotiation with individual devices of a network (e.g., according to an individual TWT, iTWT).

According to embodiments of the present disclosure, a scheduling device such as various wireless fidelity (Wi-Fi) APs, Wi-Fi direct group owners (GO), and the like can indicate an availability during interstitial periods via a broadcast TWT (bTWT). The broadcast TWT can be provided to any number of scheduled devices such as a STA or other clients. In some embodiments, during an indicated time of unavailability, the scheduling devices can remain unavailable incident to operations on another channel or other medium. In some embodiments, during an indicated time of unavailability, the scheduling devices can be available to one or more devices of a same or different basic service set (BSS), or other network organization. In some embodiments, during an indicated time of unavailability, the scheduling devices can place a transceiver, processor, or other component utilized during times of availability into a low power state.

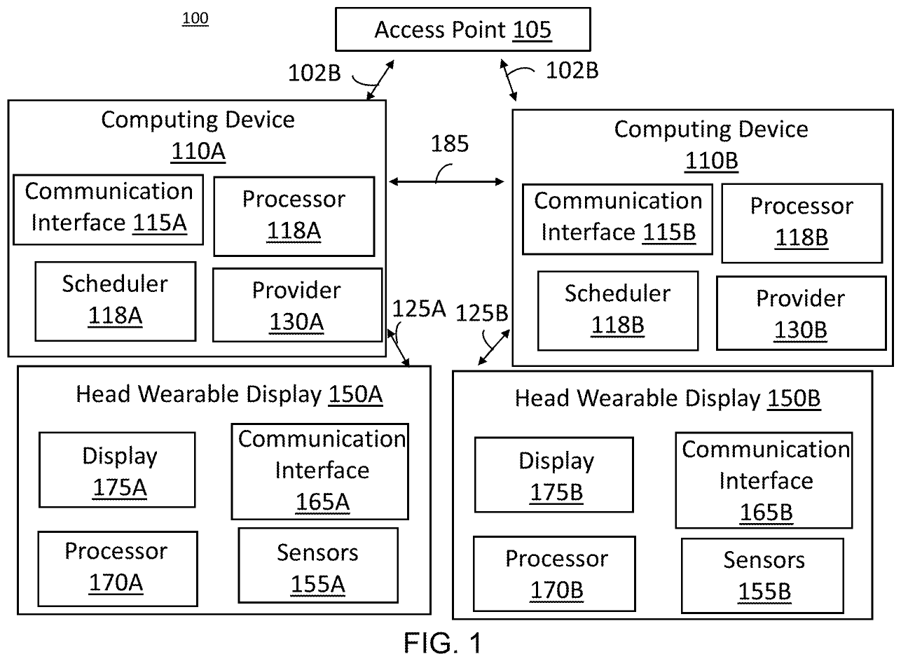

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user's view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155. In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10%) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality. In some embodiments, the processors 118, 170 may configure or cause the communication interfaces 115, 165 to toggle, transition, cycle or switch between a sleep mode (also referred to as a sleep state, without limiting effect) and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request rTWT to transmit latency sensitive traffic using P2P communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110 wish to schedule P2P communication in rTWT service periods (SPs). The scheduler 118 of the computing device(s) may schedule (or negotiate) the requested rTWT SP(s). The scheduler 118 of the computing device(s) may also indicate if the SP(s) are requested only for P2P communication (as compared to mixed P2P communication and non-P2P communication).

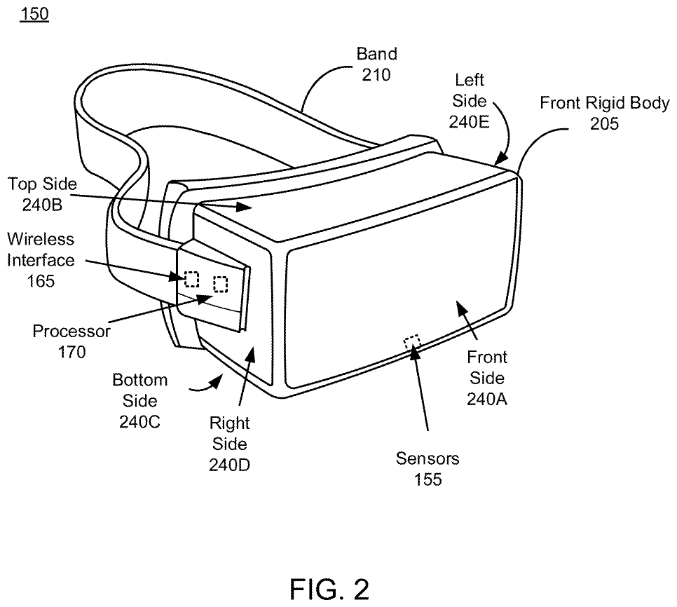

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not visible to the user. In other embodiments, the HWD 150 has a different configuration than shown in FIG. 2. For example, the processor 170, the eye trackers, and/or the sensors 155 may be in different locations than shown in FIG. 2.

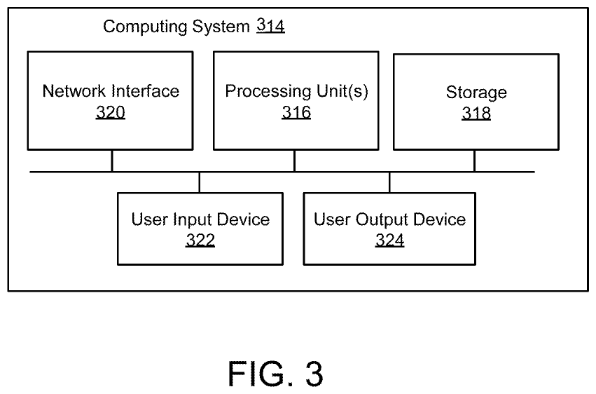

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

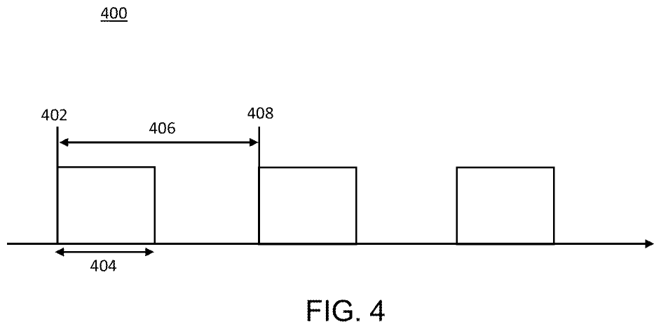

FIGS. 1-2 illustrate devices that communicate traffic streams, some of which may be latency sensitive (e.g., those carrying periodic AR/VR information/content). As described herein, the periodic operation of TWT benefits communication of periodic traffic (e.g., latency sensitive traffic) by predictably communicating the periodic traffic. For example, a periodicity may correspond to a refresh rate of a HWD 150. FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may switch to a sleep state until the next TWT start time at 408. The interval of time between TWT start time 402 and TWT start time 408 may be considered the SP interval 406. The communication and/or negotiation of the duration 404 between devices can lower energy use (e.g., wherein a device can enter a sleep state between durations 404), and improve latency/network congestion (e.g., by deferring a communication until a duration 404 when another device is expected to be awake, repeated communications and associated delays can be obviated).

A TWT schedule may be communicated and/or negotiated using broadcast TWT (bTWT) and/or individual TWT (iTWT) signaling. In some embodiments, to signal iTWT, TWT schedule information may be communicated to particular (individual) devices using a mode such as a Network Allocation Vector (NAV) to protect the medium access of TWT SPs. In contrast, to signal bTWT, in some embodiments, a device (such as AP 105) may schedule TWT SPs with other devices (e.g., computing devices 110 and/or HWDs 150) and may share schedule information in beacon frames and/or probe response frames. Sharing schedule information using bTWT may reduce overhead (e.g., negotiation overhead) as compared to the overhead used when sharing information using iTWT.

The TWT mechanism may also be used in peer-to-peer (P2P) communication. For example, TWT may be defined for tunneled direct link setup (TDLS) pairs (e.g., non-AP STAs), soft APs (such as computing devices 110) and STAs (such as HWD 150), and/or peer-to-peer group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link.

When P2P communication is established, various channel access rules may govern the P2P communication. An AP assisted P2P trigger frame sequence may reduce the contention/collision associated with TWT (or restricted TWT, rTWT) in P2P communication. The rTWT can provide enhanced medium access protection and resource reservation for latency sensitive traffic. Accordingly, a P2P model where a P2P STA (e.g., a HWD 150) is not associated with an infra-basic service set (BSS) AP, may improve communication. Without AP's assistance or coordination, a transmission over the P2P link may collide with another transmission in the BSS. In some embodiments, a reverse direction protocol (RDP) may be established for P2P communication. During RDP, when a transmitting STA has obtained a transmit opportunity (TXOP), the transmitting STA may grant permission for the receiving STA to transmit information back to the transmitting STA during the same TXOP. Accordingly, if a TWT setup allows P2P transmission and indicates RDP, the P2P communication can be performed after a triggered frame sequence (e.g., a reverse direction frame exchange). In other embodiments, other protocols may be enabled for P2P communication. In some embodiments, trigger-enabled TWT can reduce the medium contention and/or collisions between UL and DL transmissions. The trigger-enabled TWT may be indicated using a TWT information element (IE).

Some implementations may define a responder PM mode for iTWT operation (e.g., between an AP 105 and a STA). For example, a responder STA may set a responder PM mode to 1 in a TWT response frame to indicate it may be unavailable outside of established TWT (e.g., to enter an energy-conserving sleep state). However, such operation may be limited to iTWT operation such as operation of STA devices, where an AP 105 may be expected to remain available at all times (e.g., may not be power constrained or operate on other networks).

An analogous conveyance of a PM mode may not be supported for bTWT operation. Thus, some devices may be unaware of a TWT negotiated between other devices of a same BSS. Accordingly, although a responder STA (including an AP 105) may only be available during a service period (e.g., to enter a sleep state), some devices may be unaware of the unavailability. Conversely, establishing a TWT with several devices according to bilateral iTWTs with several device of a network can lead to network congestion or excessive power consumption. Such overhead communications can, in some instance, offset or even exceed power savings realized from entering a sleep state.

The responder PM mode can, according to the present disclosure, be provided via a bTWT by a network device including an AP 105. Thus, various network devices (e.g., non-AP 105 STA) can be aware of with an expected status of a device (e.g., the AP 105) outside of scheduled SP, along with various TWT parameters for the SP. According to such an implementation, an AP 105 device can enter a sleep state to save power outside of scheduled SP, or operate on other networks to densify network communications.

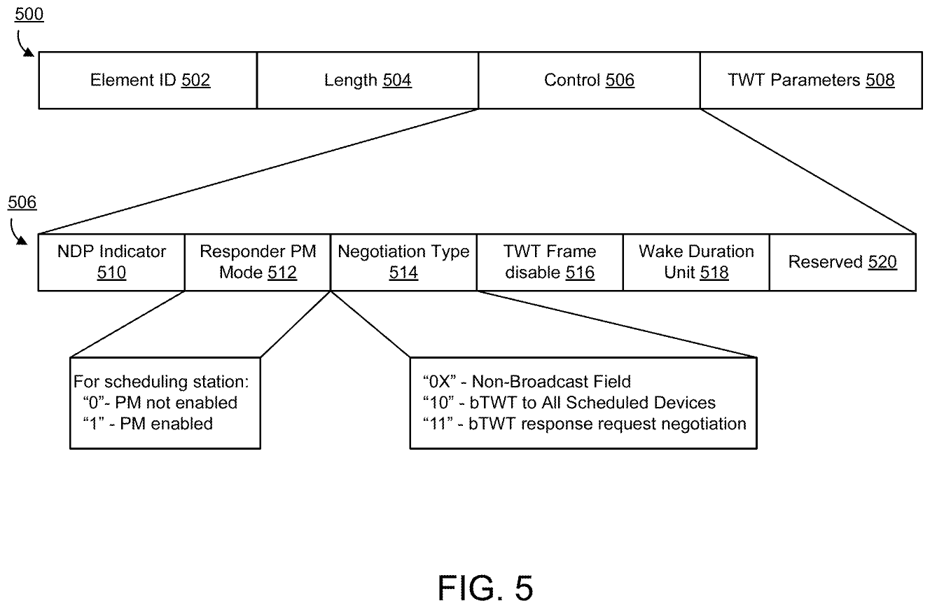

Referring now to FIG. 5, a diagram showing an example frame structure of a target wake time (TWT) element 500 is provided. The frame structure is configured for provision to one or more scheduled devices from a scheduling device. The scheduling device may include an AP 105 such as a fixed AP 105, soft AP 105 or mobile AP 105 (e.g., hotspot), a Wi-Fi direct Group Owner (GO), Tunneled Direct Link Setup (TDLS), or other device configured to provide broadcast TWT messages to network stations (STAs). The scheduled devices can include various STA associated with, for example, the AP 105 or GO.

The TWT element 500 includes an element ID 502 to identify the element as a TWT element. For example, a predefined bit pattern can identify the frame type relative to other management frames. A length field 504 can provide a length of the further portions of the TWT element 500 (e.g., exclusive and/or inclusive of the element ID 502 and/or length field 504). A control field 506 can include control data/information/fields/bits for the TWT configuration. A TWT parameters field 508 can include various parameters of a TWT. The parameters can include, for example, a TWT Wake Interval, TWT Wake Duration, and/or TWT Offset. The TWT Wake Interval (time between successive TWT sessions) may correspond to the SP interval 406 of FIG. 4. The TWT Wake Duration (e.g., how long the device stays awake) may correspond to the duration 404 of FIG. 4. The TWT Offset (e.g., the time offset for the start of the TWT session) can refer to an offset from defined network time, such as a delay prior to the start time 402.

The TWT parameters field 508 (or other data element) can further identify a broadcast TWT identifier for a set of devices. For example, the broadcast TWT identifier can identify a schedule ID of zero for an empty schedule ID (e.g., “00000”). Such an empty schedule ID can address all devices of a BSS which support broadcast TWT. For example, the schedule ID can address the various devices assigned to the broadcast identifier. Non-zero values can define additional (e.g., thirty-one) sets of devices configured to receive TWT messages during specific SPs. The devices can negotiate membership in a particular set, along with a schedule for the set (e.g., the duration 404 or interval 406 of a SP) with the scheduling device. References to broadcast TWT, bTWT herein can generally refer to a broadcast TWT provided via a beacon or probe response frame, a frame for an empty schedule ID, or a frame for another set of scheduled devices. Each set can correspond to any number of scheduled devices (e.g., zero or more). For example, any of the examples provided herein may correspond to a set of multiple scheduled devices, such that upon a transmission of the broadcast TWT message, the multiple scheduled devices receive an indication of a PM mode for the scheduling device. Such broadcast messages can lower an overhead, relative to individual negotiations with each scheduled device to establish SPs and provide a PM mode indication with an iTWT.

With further reference to the control field 506, the control data can include a Non-scheduled Delivery Paging (NDP) indicator subfield 510. The NDP indicator subfield 510 can indicate whether a TWT session associated with the TWT element 500 utilizes scheduled TWT sessions or NDP TWT sessions. For example, the NDP indicator subfield 510 can indicate that TWT sessions are scheduled according to the TWT parameters field 508 according to a cleared (“0”) bit.

The responder PM mode subfield 512 of the control field 506 may indicate a power management (PM) mode provided by a responder device. For example, when cleared to a “0,” the responder (e.g., scheduling device, such as an AP 105) may remain available outside of SPs. Scheduled devices may initiate communication with an AP 105 outside of a SP responsive to receiving an indication of a PM mode 512 subfield of “0” received from the scheduling device. When set to a “1,” the responder may not be available outside of scheduled SP. Scheduled devices may delay or abort communication with an AP 105 outside of a SP responsive to receiving an indication of a PM mode subfield of “1” from the scheduling device. In some instances, the responder PM mode subfield 512 may be referred to as a “passive mode” rather than “power management” mode, without limiting effect.

The negotiation type subfield 514 of the control field 506 may indicate a type of TWT being negotiated. The negotiation can include a request, suggestion, demand, acceptance, alternation, dictation, or rejection of one or more TWT parameters of the TWT parameters subfield 508. The negotiation type subfield 514 can include two-bits corresponding to four potential values of a negotiation type, 0, 1, 2, and 3. The most significant bit of the negotiation type subfield 514 may indicate a presence of one or more broadcast fields, wherein negotiation types 0 or 1 do not refer to bTWT. Negotiation type 2 can include or refer to a broadcast to all frames which commands (e.g., sets, provides, specifies, includes) at least a portion of the TWT parameters. Negotiation type 2 can include or refer to request response negotiation, wherein the various scheduled devices are invited to confirm received TWT parameters, provide alternate TWT parameters, or so forth.

The TWT frame disable subfield 516 can indicate that a receipt of TWT frames is disabled by the responder (e.g., the scheduling station). The wake duration unit 518 can depict a value according to a number of provided 1024 microsecond time units (TU), or a fixed time such as 256 microseconds. A reserved subfield 520 can include register space for future revisions, proprietary implementations, and so forth.

Further information related to TWT operation can be included in any number of further information elements (e.g., fields, subfields, and so forth). For example, a high-efficiency (HE) operation parameter can be included in a beacon or other frame. One such parameter can include a “TWT Required” field, provided as a bit value to indicate that a STA is required to support TWT operations for association with a BSS. Thus, upon or incident to association with a scheduling device, scheduled devices can indicate support for bTWT operations. Likewise, a scheduling device can provide an indication of a PM mode 512. According to the PM mode 512, the scheduling device may be available or unavailable between scheduled SP.

In some embodiments, the scheduling device can provide a PM mode 512 incident to a beacon or probe response frame, where the same PM mode 512 is delivered to all scheduled devices associated with a same BSS as the scheduling device. In some embodiments, the scheduling device can provide a PM mode 512 along with an empty schedule ID field, to provide the indication to all scheduled devices configured to receive the PM mode 512. For example, where all scheduling device are configured to receive the PM mode 512 (e.g., because the scheduling device restricts BSS membership to devices configured to receive the PM mode 512). In some embodiments, such an indication may be propagated to all devices of a BSS. In some embodiments, the scheduling device can provide a PM mode 512 along with a non-empty schedule ID field (e.g., IDs 1-31), to provide the PM mode 512 to a sub-set of scheduled devices of the BSS.

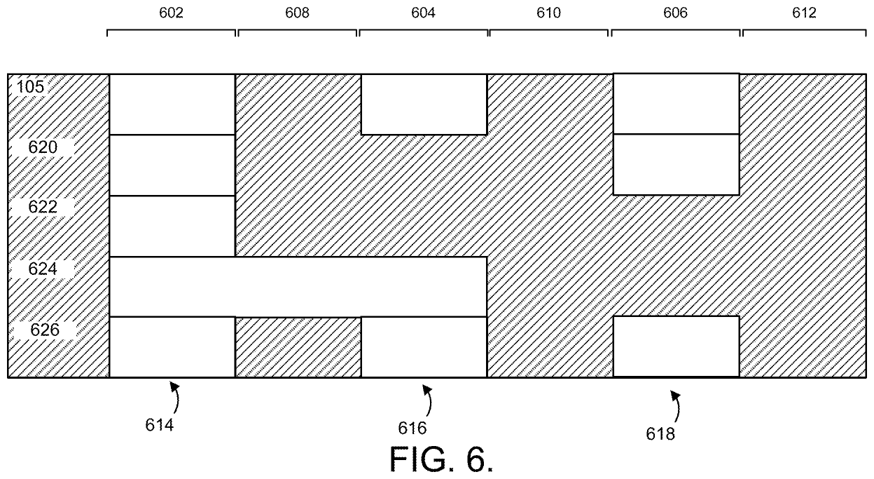

Referring now to FIG. 6, a timing diagram 600 showing a schedule of computing devices of a basic service set (BSS) utilizing TWT is provided, according to an example implementation of the present disclosure. More particularly, the timing diagram 600 provides an availability of an AP 105 of a BSS, and various non-AP STAs of the same BSS. According to various embodiments of the present disclosure, the AP 105 can be substituted for various TWT scheduling devices such as GOs, or TDLSs, wherein the STAs can correspond to scheduled devices associated with such a scheduling device.

The timing diagram 600 may correspond to a network in which the AP 105 has negotiated SP schedules with various STA devices. For example, the first SP 602 corresponds to each of a first STA 620, second STA 622, third STA 624, and fourth STA 626. In some embodiments, the respective STAs 620, 622, 624, 626 (collectively, SP1 set 614) can be every STA of a BSS. For example, the AP 105 may have established the SP group according to an empty schedule ID of the various devices supporting broadcast TWT, or via a beacon/response probe. In some embodiments, the AP 105 may indicate, via a beacon frame or TWT parameter field 508, that all STA of the BSS are to support TWT (e.g., bTWT). Such an indication can include setting a “TWT Required” bit in a broadcast frame. Thus, according to various embodiments, an SP can correspond to all STA of a BSS or a subset thereof. Further, the AP 105 may have negotiated a second SP 604 for the third STA 624 and fourth STA 626 (collectively, SP2 set 616). Further, the AP 105 may have negotiated a third SP 606 for the first STA 620 and fourth STA 626 (collectively, SP3 set 618). The negotiation of the various SPs can include an indication of responder PM mode 512 of the AP 105, indicating an unavailability of the AP 105 during the various interstitial periods when an AP 105 is not available. Such a PM mode 512 can be a same mode for all of the SP (e.g., as provided to the sets 614, 616, 618 corresponding thereto).

A first interstitial period 608 separates the first SP 602 from the second SP 604. A second interstitial period 610 separates the second SP 604 from the third SP 606. A third interstitial period 612 follows the third SP 606 (e.g., prior to a fourth SP (not depicted) or a second instance of the first SP 602).

During the first SP 602, any of the SP1 set 614 of STA can communicate with the AP 105, and the AP 105 can communicate with any of the STA of the SP1 set 614. Following a closure of the first SP 602, and prior to a subsequent SP including the third STA 624 (e.g., during the first interstitial period 608), the third STA 624 can generate uplink traffic. For example, the third STA 624 may not switch to a sleep state during the first interstitial period 608, or may switch to a sleep state and thereafter exit the sleep state responsive to a receipt of information (e.g., a locally driven interrupt or other traffic generator).

The third STA 624 can determine, based on a prior provision of a responder PM mode subfield 512, that the AP 105 is unavailable during the first interstitial period 608. In some embodiments, the third STA 624 may re-enter a sleep state (or defer exiting the sleep state) prior to a subsequent SP based on the provision of the responder PM mode field 512. The responder PM mode field 512 can be provided to each device of the respective SPs as a broadcast message. Thus, for a SP set of 1, 2, or 255 devices, the transmission (or broadcast) of a single responder PM mode field 512 can provide an indication of unavailability. In some embodiments, the AP 105 can provide separate indications to separate STAs. For example, the AP 105 may be available with respect to one set of STA (e.g., a first priority set) and may be unavailable to another set of STA (e.g., a second priority set).

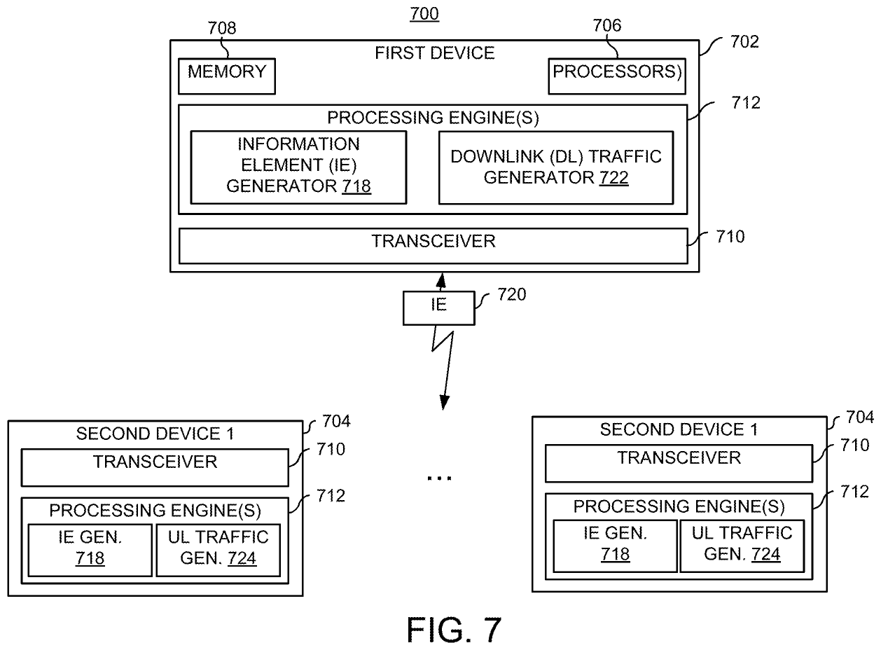

Referring to FIG. 7, a block diagram of a computing environment 700 is provided, according to an example implementation of the present disclosure. The computing environment 700 may include a first device 702 and any number second devices 704 (referred to generally as a second device 704). The first device 702 may be or include a scheduling and/or responder station such as an AP 105 (e.g., soft AP 105) a Wi-Fi direct GO, or the like. The first device 702 can be configured to operate in one or more modes of operations or in one or more networks. For example, a HWD 150 can be a second device 704 communicatively coupled with a first device 702 (e.g., operate as a STA of a Wi-Fi router), and also operate as a first device 702 communicatively coupled with a second device 704 (e.g., as an AP for another STA such as a computing device 110, peripheral device, or another HWD 150). The first device 702 (and second device 704) may include one or more processors 706 and memory 708, which may be similar, respectively, to the processor(s) 118/170 or processing units 316 and storage 318 described above with reference to FIG. 1-FIG. 3. The first device 702 and second device 704 may include respective transceivers 710 and processing engine(s) 712. The transceivers 710 may be similar to the communication interface(s) 115, 165 and the processing engine(s) 712 may be similar to the processing unit(s) 316, described above with reference to FIG. 1-FIG. 3.

As described in greater detail below, the first device 702 may be configured to generate/establish information elements (IE) 720 for transmission (in a message) to the second device(s) 704. The IE 720 may encode TWT parameters 508, control data, and other TWT data between the first device 702 and second device(s) 704, such as to associate various scheduled devices with a BSS, establish a TWT, adjust the TWT, or provide an indication of an availability outside of scheduled SP (e.g., a responder PM mode subfield 512). The first device 702 may be configured to transmit, send, communicate, or otherwise provide the IE 720 to the second device 704. The second device 704 may be configured to transmit, send, communicate, or otherwise provide further IE 720 to the first devices. For example, the IE 720 provided by the second device can include IE 720 incident to BSS association with the first device 702, or negotiation of SP with the first device 702.

The first device 702 and second device 704 may support various TWT functionalities/tasks/functions for communication during a session between the devices 702, 704. The first device 702 may include an information element (IE) generator 718. The IE generator 718 may be or include any device, component, processor, circuitry, or hardware designed or configured to establish, produce, create, or otherwise generate an IE 720 for transmission to the second device 704. For example, the IE generator 718 of the first device 702 can generate an IE 720 to encode a responder PM mode subfield 512 for conveyance to a second device 704. In some embodiments, the IE generator 718 of the first device 702 can generate an IE 720 to encode a TWT required bit or other subfield, for provision to the second device 704. An IE generator 718 of the second device 704 can generate an IE 720 to associate with or otherwise indicate a supported TWT operation (e.g., bTWT). The IE generators 718 may be configured to generate further IEs 720 to configure or establish the session between the first device 702 and second device 704, or otherwise maintain a communicative connection between the various devices of a network.

The first device 702 can include a DL traffic generator 722 configured to generate DL traffic. The DL traffic generator 722 can generate the traffic according to a local process, based on another device of a BSS including the first device 702 and the second devices 704, or another device, such as a remote service communicatively coupled with the first device 702 (e.g., the Internet). The DL traffic generator 722 can generate traffic asynchronously to a scheduled SP, such that the DL traffic generator 722 can schedule the DL traffic according to a mode of the second device 704 (e.g., during an SP for a second device 704 which is not available outside of an SP, or immediately for a second device 704 which is available outside of an SP). In various embodiments, the DL traffic generator 722 can schedule the DL traffic according to various data types, such as a DL traffic priority or other type. For example, the DL traffic generator 722 can schedule some DL traffic only during SP and other DL traffic outside of scheduled SP according to a traffic type.

One or more (e.g., all) of the second devices 704 can include an UL traffic generator 724 configured to generate UL traffic. The UL traffic generator 724 can generate the traffic according to a local process, based on another device of a BSS including the first device 702 and the second devices 704 (e.g., a P2P communication), or another device, such as a remote service communicatively coupled with the second device 704 (e.g., the Internet). The UL traffic generator 724 can generate traffic asynchronously to a scheduled SP, such that the UL traffic generator 724 can schedule the UL traffic according to a mode of the first device 702 (e.g., during an SP for a first device 702 which is not available outside of an SP, or immediately for a first device 702 which is available outside of an SP, as indicated by a PM mode subfield 512). In various embodiments, the UL traffic generator 724 can schedule the UL traffic according to various data types, such as an UL traffic priority. For example, the UL traffic generator 724 can schedule some UL traffic only during SP and other UL traffic outside of scheduled SP according to a traffic type.

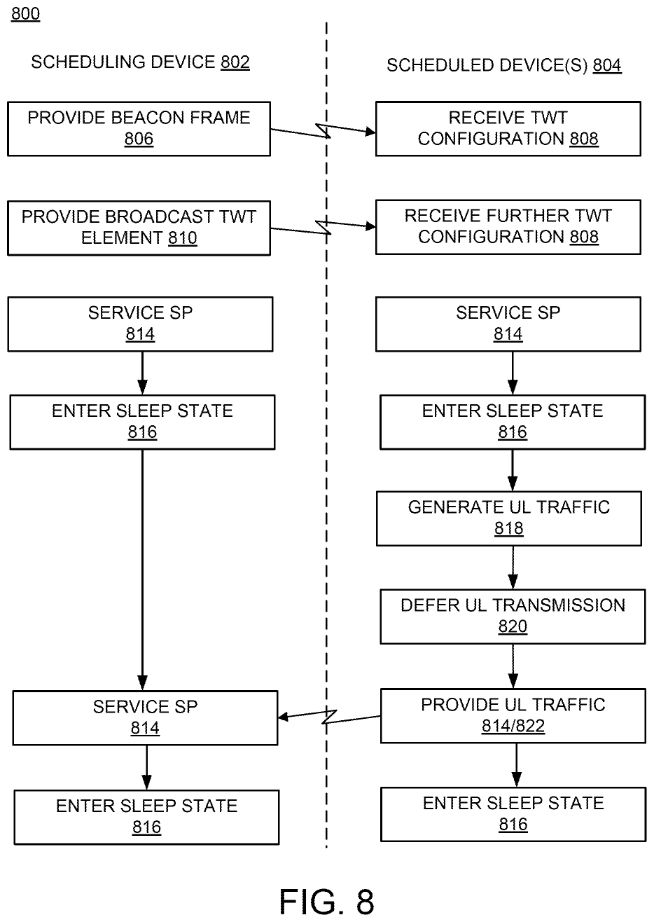

Referring now to FIG. 8, a flowchart showing an example method 800 of TWT broadcast scheduling is provided, according to an example implementation of the present disclosure. The method 800 may be performed by various devices, components, or elements described above with reference to FIG. 1-FIG. 7. In some embodiments, some steps, operations, or processes of the method 800 may be performed by a scheduling device 802, and other steps or processes of the method 600 may be performed by scheduled devices 804 associated with the scheduling device. For example, the scheduled device 804 and scheduling devices 802 can be devices of a same BSS, wherein the scheduling device 802 (e.g., the first device 702 of FIG. 7) is configured to provide broadcast frames to scheduled devices 804 (or STAs) of the BSS (e.g., the scheduling device 802 may be an AP 105 or GO). The scheduled device 804 (e.g., the second device 704 of FIG. 7) can include a non-AP device, such as various STAs of a same BSS.

At operation 806, the scheduling device 802 provides a beacon frame to the scheduled device 804. In some embodiments, the beacon frame can convey a TWT required subfield in a high efficiency (HE) operation parameters element. In some embodiments, such a subfield can be included in other frames such as a probe response frame, association response frame, or reassociation response frame. In some embodiments, the same or another beacon frame can include the TWT element of operation 810 described below.

The scheduled device 804 may receive the TWT configuration at operation 808. In some embodiments, the TWT configuration can include an indication of a TWT support of a BSS in a beacon frame (e.g., that a scheduled device 804 of a BSS supports TWT operation, or requires TWT operation). In some embodiments, the TWT configuration can include an indication of an availability of the scheduling device 802 between service periods, such as a responder PM mode sub-field 512. Based on the receipt of the TWT configuration, the scheduled device 804 can select a mode of TWT operation, may associate with the scheduling device 802, or not associate with the scheduling device 802.

At operation 810, the scheduling device 802 provides a broadcast TWT element to the scheduled device 804. Such a response element may be provided responsive to a receipt of a TWT request element received from one or more scheduled devices 804, or otherwise provided (e.g., in a beacon or probe response frame, as indicated above, a TWT response frame, or otherwise as a management frame to manage BSS operations). The scheduled device 804 may receive a TWT configuration at operation 808. The received TWT configuration may supplement, append, or overwrite a previously communicated TWT configuration. Indeed, the TWT configuration may be updated at various points prior to, during, or subsequent to the operations of the depicted method 800.

At operation 814, various devices of the BSS can service the SP (e.g., utilize any portion of the SP, perform one or more operations, or perform/provide/deliver one or more services, in/within/during the SP). For example, the scheduling device 802 can provide any queued traffic (e.g., DL traffic) to the various scheduled devices 804 and the scheduled devices 804 can provide any queued traffic (e.g., UL traffic) to the scheduling device 802. In some embodiments, traffic available for transmittal (e.g., transmission) may not be provided during the SP. For example, the quantity of traffic queues for transmittal can exceed an amount of traffic transmittable during the duration 404 of the SP prior to the closure. However, one or more devices may have indicated an unavailability outside of the SP (e.g., the scheduling device, at operations 806 or otherwise at operation 810). Thus, traffic may be deferred to a subsequent SP (e.g., by providing the deferred traffic in a queue for subsequent transmission in the subsequent SP). In some embodiments, all traffic may be communicated during the SP.

At operation 816, various devices of the BSS can become unavailable. In some embodiments, the scheduling device 802 can switch to or enter the sleep state (or switch to another channel). In some embodiments, one or more scheduled devices 804 can switch to the sleep state (or switch to another channel). Various devices of the BSS can perform different actions. Moreover, during interstitial periods outside of a service period, such devices can perform different actions. Such actions can include, for example, switching to a different channel, or switching to a sleep state. The sleep state can include a reduced power mode of a transceiver 710, processing engine 712, or other portion thereof.

At operation 818, the scheduled device 804 can locally generate UL traffic. The locally generated traffic may be responsive to a receipt of information from another STA, a user interface, a locally driven interrupt, another wired or wireless network connection, etc. The traffic may be generated subsequent to a closure (e.g., termination or end) of a first SP and prior to an opening (e.g., start, beginning, initialization) of a subsequent SP. At operation 820, the scheduled device 804 can defer transmission of the UL traffic generated at operation 818. The deferral may be responsive to the receipt of the TWT configuration, such as the receipt of the responder PM mode sub-field 512 at operations 806 or 810.

At operation 822, the scheduled device 804 can provide the deferred UL traffic to the scheduling device 802. The provision can be according to a flow control or other traffic management technique for servicing the SP (e.g., corresponding to operation 814). For example, the scheduling device 802 or scheduled device 804 can solicit or provide traffic responsive to a priority, predefined sequence, or other flow control, QoS, or other data flow management of the BSS.

Upon a closure of the SP, either or both of the scheduling device 802 and scheduled device 804 can close/end/terminate/exit a period of availability. As referred to with respect to operation 816, such a period of availability can be terminated according to one or more devices switching to a sleep state, to a different channel or other mode of operation, or so forth.

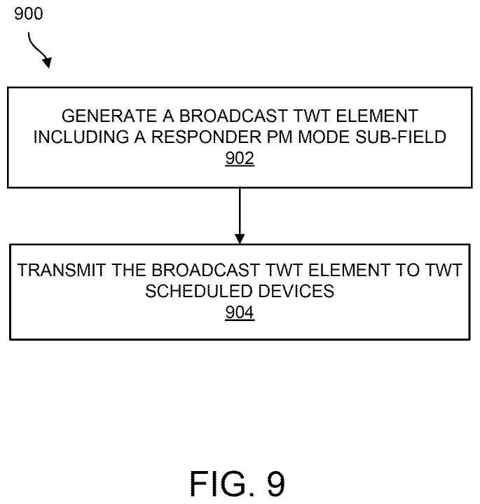

FIG. 9 is a flowchart showing an example method of TWT broadcast scheduling, according to an example implementation of the present disclosure. The method 900 may be performed by various devices, components, or elements described above with reference to FIG. 1-FIG. 8. In some embodiments, some steps, operations, or processes of the method 900 may be performed by a TWT scheduling device 802 (e.g., AP 105 or GO) associated with one or more scheduled devices. For example, the method 900 can be performed by an AP 105, GO, or other device configured to provide broadcast TWT frames to scheduled devices in a Wi-Fi network environment.

A responder PM mode bit may be used for indicating a responder STA (e.g., including an AP 105) may only be available or operating during certain service periods. Since individual TWTs are negotiated between two entities (e.g., the AP 105 and STA), other STAs may be unaware of the responder PM operation. As such, a given AP 105 may need to set the responder PM mode bit with multiple STAs, and as such individual responder PM may not be scalable. Since broadcast TWT schedules are announced in the BSS, all associated STAs may learn that the AP 105 is operating in that mode.

In various embodiments, an AP 105 may broadcast a responder PM mode to multiple STAs, to establish or maintain the responder PM mode across those STAs thereby achieving/enabling/having power savings.

At operation 902, the TWT scheduling device 802 may generate a broadcast TWT element including a control field 506. The control field 506 can include a responder PM mode sub-field 512. The responder PM mode sub-field can encode an indication of an availability of the scheduling device 802 outside of scheduled SP. For example, the responder PM mode sub-field 512 can indicate a “1” to indicate that the scheduling device 802 will be available outside of scheduled SPs, and a “0” to indicate that the scheduling device 802 is to be (e.g., will be) unavailable outside of scheduled SPs. The control field 506 of the TWT element 500 can further indicate a broadcast negotiation. For example, the uppermost bit of the negotiation type field may be set to one to indicate a broadcast message. That is, the control field 506 of the broadcast TWT element can be provided for a type 2 negotiation or a type 3 negotiation.

At operation 904, the TWT scheduling device 802 may transmit the broadcast TWT element to one or more TWT scheduled devices 804 within a BSS of the TWT scheduling device. In some embodiments, the TWT scheduling device 802 transmits the broadcast TWT element during a pre-scheduled SP, prior to negotiation thereof, or incident to such a negotiation. For example, the TWT scheduling device 802 may transmit the broadcast TWT element as a part of a beacon frame or in response to a TWT request, such as in a TWT response frame. The TWT scheduled device 802 can received the TWT request. The transmission of the broadcast TWT element may be responsive to the receipt of the TWT request. In some embodiments, the scheduling device 802 may broadcast the TWT response frame (e.g., including the broadcast TWT element) for receipt by each of the one or more TWT scheduled devices 804 within the BSS. For example, an AP 105 can broadcast a responder PM mode sub-field 512 for all associated STA of a BSS.

In some embodiments, the TWT scheduling device 802 may determine or control a TWT support of various TWT scheduled devices 804 of a BSS shared with the TWT scheduling device 802. For example, the TWT scheduling device 802 can set a value for a TWT required subfield in a high efficiency (HE) operation parameters element to accord with a value of the responder PM mode sub-field 512 of the broadcast TWT element 500. Such a setting can restrict BSS access to TWT supporting (e.g., bTWT supporting) scheduled devices 804. According to a determination or control that the various scheduled devices support TWT (e.g., bTWT) operations, the TWT scheduling device 802 can transmit the indication of availability. For example, in response to determining that each of the one or more TWT scheduled devices support a broadcast TWT operation, the TWT scheduling device 802 may set a value for the responder PM mode sub-field. Responsive to validating a supported operation by each of the one or more scheduled devices 804, the scheduling device 802 can presume that it is not to (e.g., will not) receive traffic between SPs, according to the setting of the responder PM mode sub-field 512.

The TWT scheduling device 802 may switch to a sleep state outside of a TWT SP according to a value of the responder PM mode sub-field 512. For example, by setting the responder PM mode sub-field 512 to “1,” the TWT scheduling device 802 may eliminate traffic during interstitial periods and can enter or switch to the sleep state to reduce a power (consumption) level. The TWT scheduling device 802 may switch to the sleep state outside of the service period for multiple TWT schedules (e.g., corresponding to multiple scheduled devices). For example, one or more of the multiple schedules can include any of a broadcast TWT schedule, a restricted TWT schedule, an individual TWT schedule, combinations thereof, or the like.

The TWT scheduling device 802 may switch to a different channel outside of a TWT SP according to a value of the responder PM mode sub-field 512. For example, by setting the responder PM mode sub-field 512 to “1,” the TWT scheduling device 802 may eliminate traffic during interstitial periods and can switch the channel to communicate with further devices. For example, the different channel can include another channel of the same BSS, or a channel corresponding to a channel for a second BSS. In some embodiments, the second channel can correspond to another mode of operation. For example, the scheduling device 802 can include an AP 105, and can switch to another channel to operate as either an AP 105 or a STA. In some embodiments, the TWT scheduling device 802 may switch to the different channel outside of the service period for multiple TWT schedules (e.g., corresponding to multiple scheduled devices 804). For example, one or more of the multiple schedules can include any of a broadcast TWT schedule, a restricted TWT schedule, an individual TWT schedule, combinations thereof, or the like.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
generating, by a target wake time (TWT) scheduling device, a broadcast TWT element, the broadcast TWT response element comprising a control field including a responder passive mode (PM) mode sub-field; and
transmitting, by the TWT scheduling device, the broadcast TWT element to one or more TWT scheduled devices within a basic service set (BSS) of the TWT scheduling device.

2. The method of claim 1, wherein transmitting the broadcast TWT element comprises broadcasting, by the TWT scheduling device, the broadcast TWT element for receipt by each of the one or more TWT scheduled devices within the BSS of the TWT scheduling device.

3. The method of claim 2, wherein the broadcast TWT element is for a type 3 negotiation for a TWT schedule.

4. The method of claim 1, further comprising:
receiving, by the TWT scheduling device, a TWT request from a TWT scheduled device,
wherein transmitting the broadcast TWT element comprises:
transmitting, by the TWT scheduling device, the broadcast TWT element in a TWT response frame to the TWT scheduled device responsive to the TWT request.

5. The method of claim 4, wherein the broadcast TWT element is for a type 2 negotiation for a TWT schedule.

6. The method of claim 1, further comprising:
determining, by the TWT scheduling device, that each of the one or more TWT scheduled devices supports a broadcast TWT operation,
wherein the TWT scheduling device sets a value for the responder PM mode sub-field responsive to determining that each of the one or more TWT scheduled devices support the broadcast TWT operation.

7. The method of claim 1, wherein the TWT scheduling device comprises an access point, and wherein the one or more TWT scheduled devices comprise one or more station devices.

8. The method of claim 1, further comprising:
switching, by the TWT scheduling device, to a sleep state outside of a service period of a TWT schedule for the BSS, according to a value of the responder PM mode sub-field.

9. The method of claim 8, wherein the TWT scheduling device switches to the sleep state outside of the service period of any of a plurality of TWT schedules for the BSS, the plurality of TWT schedules comprising one or more of a broadcast TWT schedule, a restricted TWT schedule, or an individual TWT schedule.

10. The method of claim 1, further comprising:
switching, by the TWT scheduling device, from a first channel corresponding to the BSS, to a second channel, outside of a service period of a TWT schedule for the BSS on the first channel, according to a value of the responder PM mode sub-field.

11. The method of claim 10, wherein the TWT scheduling device switches to the second channel outside of the service period of any of a plurality of TWT schedules for the BSS on the first channel, the plurality of TWT schedules comprising one or more of a broadcast TWT schedule, a restricted TWT schedule, or an individual TWT schedule.

12. The method of claim 1, further comprising:
setting, by the TWT scheduling device, a value for a TWT required subfield in a high efficiency (HE) operation parameters element, according to a value of the responder PM mode sub-field of the broadcast TWT response element.

13. A device comprising:
a transceiver; and
one or more processors configured to:
generate a broadcast target wake time (TWT) element, the broadcast TWT element comprising a control field including a responder passive mode (PM) mode sub-field;
transmit, via the transceiver, the broadcast TWT element to one or more TWT scheduled devices within a basic service set (BSS) of the TWT scheduling device.

14. The device of claim 13, wherein the one or more processors are configured to transmit the broadcast TWT element by broadcasting the broadcast TWT element for receipt by each of the one or more TWT scheduled devices within the BSS of the TWT scheduling device.

15. The device of claim 13, wherein the one or more processors are configured to:
receive, via the transceiver, a TWT request from a TWT scheduled device; and
transmit, via the transceiver, the broadcast TWT element to the one or more TWT scheduled devices in a TWT response frame responsive to the TWT request.

16. The device of claim 13, wherein the one or more processors are configured to:
determine that each of the one or more TWT scheduled devices support a broadcast TWT operation; and
set a value for the responder PM mode sub-field responsive to determining that each of the one or more TWT scheduled devices support the broadcast TWT operation.

17. The device of claim 13, wherein the one or more processors are configured to:
switch the device to a sleep state outside of a service period of a TWT schedule for the BSS, according to a value of the responder PM mode sub-field.

18. The device of claim 17, wherein the one or more processors switch the device to the sleep state outside of the service period of any of a plurality of TWT schedules for the BSS, the plurality of TWT schedules comprising one or more of a broadcast TWT schedule, a restricted TWT schedule, or an individual TWT schedule.

19. The device of claim 13, wherein the one or more processors are configured to:
switch from a first channel corresponding to the BSS, to a second channel, outside of a service period of a TWT schedule for the BSS on the first channel, according to a value of the responder PM mode sub-field.

20. The device of claim 19, wherein the one or more processors switch to the second channel outside of the service period of any of a plurality of TWT schedules for the BSS on the first channel, the plurality of TWT schedules comprising one or more of a broadcast TWT schedule, a restricted TWT schedule, or an individual TWT schedule.
